(19) United States
(12) Patent Application Publication
(10) Pub. No.: US 2024/0073960 A1
(43) Pub. Date: Feb. 29, 2024

(54) Random Access Comprising Sending or Receiving a MSG3 Message

(71) Applicant: Telefonaktiebolaget LM Ericsson (pub), Stockholm (SE)

(72) Inventors: Istiak Hossain, Kista (SE); Andreas Höglund, Solna (SE); Tuomas Tirronen, Helsinki (FI); Stefan Wänstedt, Luleå (SE); Henrik Enbuske, Stockholm (SE); Jan Christoffersson, Luleå (SE)

(21) Appl. No.: 18/260,539

(22) PCT Filed: Jan. 13, 2022
(86) PCT No.: PCT/SE2022/050029

§ 371 Date: Jul. 6, 2023

Related U.S. Application Data
(60) Provisional application No. 63/137,308, filed on Jan. 14, 2021.

(51) Int. Cl. H04W 74/08; H04W 8/24

(52) U.S. Cl. CPC H04W 74/0833; H04W 8/24

(57) ABSTRACT

Methods and apparatus are disclosed. In an example, a method performed by a wireless device for performing random access is disclosed. The method comprises transmitting a Msg3 message to a network node, wherein the Msg3 message includes an indication of whether the wireless device is a reduced capability wireless device.

### TECHNICAL FIELD

Embodiments of this disclosure relate to random access, for example in a wireless communication system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reduced capability NR devices

5G is designed to support high speed, low latency wireless communication to serve different market verticals of the communication service domain. 5G cellular technology was introduced in 3GPP Release 15. The 5G system (5GS) includes both a new radio access network (NG-RAN), which makes use of a new air interface called New Radio (NR), and a new core network (5GC).

So far, Release 15 and 16 of NR are optimized to support enhanced mobile broadband (eMBB) and ultra-reliable and low latency communication (URLLC) through 5GS. These services require very high data rates and/or low latency. Hence, these services put high requirements on the 5G UE.

To enable 5G to be used for other services, with relaxed performance requirements, than eMBB and URLLC; a reduced capability (RedCap) UE type is introduced in Release 17 [Error!Reference source not found.]. The RedCap UE type is particularly suited for services with medium demand such as Industrial wireless sensors, wearables, or video surveillance.

To provide a less expensive device for the abovementioned services, the RedCap UE has reduced capabilities compared to a Release 15/16 NR UE. So far, in RAN #90e, the following objectives have specified for UE complexity reduction features:
Reduced maximum UE bandwidth
Reduced minimum number of Rx branches
Maximum number of DL MIMO layers
Relaxed maximum modulation order
Duplex operation

Additional objectives may be added in RAN #91e based on the RAN2 part of the RedCap SI's finalization.

Additionally, the low complexity UEs (also referred to herein as reduced capability wireless devices or reduced capability UEs) must be only used for their intended use cases to assure resource utilization and SLA-based service scaling from the operator side. The network must identify the low complexity UEs and restrict their access when necessary to enforce this requirement. This is captured in the 3GPP work item description for the low complexity UE [Error! Reference source not found.] as:
Specify definition of RedCap UE type(s) including set(s) of L1 capabilities for RedCap UE identification and for constraining the use of those RedCap L1 capabilities only for RedCap UEs, and preventing RedCap UEs from using capabilities not intended for RedCap UEs including at least carrier aggregation, dual connectivity and wider bandwidths.
Specify functionality that will enable RedCap UEs to be explicitly identifiable to networks and allow operators to restrict their access if desired.

In 3GPP, an indication to early identify that the UE is a RedCap device has been discussed for both the above reasons, i.e., to schedule the UE according to its lower capabilities and be able to restrict the access according to the objective above.

So far, in the Release 17 RedCap (RAN1 and RAN2) study item, it is identified that an early indication for RedCap devices is needed. The discussion regarding the design of such as is still open.

### SUMMARY

There currently exist certain challenge(s). For example, A gNB must be able to decide if a RedCap device should be allowed in a cell. There are no agreed means to identify a RedCap device about to receive access to a cell. Further, to best support RedCap devices in NR there must be a means to understand its capabilities before data needs to be scheduled.

An example aspect of this disclosure provides a method performed by a wireless device for performing random access. The method comprises transmitting a Msg3 message to a network node, wherein the Msg3 message includes an indication of whether the wireless device is a reduced capability wireless device.

Another example aspect of this disclosure provides a method performed by a network node for random access. The method comprises receiving a Msg3 message from a wireless device, wherein the Msg3 message includes an indication of whether the wireless device is a reduced capability wireless device.

A further example aspect of this disclosure provides apparatus in a wireless device for performing random access. The apparatus comprises a processor and a memory. The memory contains instructions executable by the processor such that the apparatus is operable to transmit a Msg3 message to a network node, wherein the Msg3 message includes an indication of whether the wireless device is a reduced capability wireless device.

A still further aspect of this disclosure provides apparatus in a network node for random access. The apparatus comprises a processor and a memory. The memory contains instructions executable by the processor such that the apparatus is operable to receive a Msg3 message from a wireless device, wherein the Msg3 message includes an indication of whether the wireless device is a reduced capability wireless device.

Another aspect of this disclosure provides apparatus in a wireless device for performing random access. The apparatus is configured to transmit a Msg3 message to a network node, wherein the Msg3 message includes an indication of whether the wireless device is a reduced capability wireless device.

An additional aspect of this disclosure provides apparatus in a network node for random access. The apparatus is configured to receive a Msg3 message from a wireless device, wherein the Msg3 message includes an indication of whether the wireless device is a reduced capability wireless device.

### BRIEF DESCRIPTION OF THE FIGURES

For a better understanding of examples of the present disclosure, and to show more clearly how the examples may be carried into effect, reference will now be made, by way of example only, to the following drawings in which:

FIG. 1 shows an example of a MAC subheader;

FIG. 2 shows another example of a MAC subheader;

FIG. 3 shows another example of a MAC subheader;

FIG. 4 depicts a method performed by a wireless device for performing random access in accordance with particular embodiments;

FIG. 5 illustrates a schematic block diagram of an apparatus for performing random access in a wireless network;

FIG. 6 depicts a method performed by a network node for random access in accordance with particular embodiments;

FIG. 7 illustrates a schematic block diagram of an apparatus for performing random access in a wireless network;

FIG. 8 shows an example of a wireless network in accordance with some embodiments;

FIG. 9 shows an example of a User Equipment in accordance with some embodiments;

FIG. 10 shows an example of a virtualization environment in accordance with some embodiments;

FIG. 11 shows an example of a telecommunication network connected via an intermediate network to a host computer in accordance with some embodiments;

FIG. 12 shows an example of a host computer communicating via a base station with a user equipment over a partially wireless connection in accordance with some embodiments;

FIG. 13 shows examples of methods implemented in a communication system including a host computer, a base station and a user equipment in accordance with some embodiments;

FIG. 14 shows examples of methods implemented in a communication system including a host computer, a base station and a user equipment in accordance with some embodiments;

FIG. 15 shows examples of methods implemented in a communication system including a host computer, a base station and a user equipment in accordance with some embodiments; and

FIG. 16 shows examples of methods implemented in a communication system including a host computer, a base station and a user equipment in accordance with some embodiments.

### DETAILED DESCRIPTION

Certain aspects of the present disclosure and their embodiments may provide solutions to these or other challenges. For example, embodiments as disclosed herein relate to a Msg3 indication during random access that identifies a device as a reduced capability (RedCap) wireless device.

There are, proposed herein, various embodiments which address one or more of the issues disclosed herein. For example, a first aspect of this disclosure provides a method performed by a wireless device for performing random access, the method comprising transmitting a Msg3 message to a network node, wherein the Msg3 message includes an indication of whether the wireless device is a reduced capability wireless device. Another aspect of this disclosure provides a method performed by a network node for random access, the method comprising receiving a Msg3 message from a wireless device, wherein the Msg3 message includes an indication of whether the wireless device is a reduced capability wireless device

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

According to one aspect of this disclosure, a method performed by a wireless device is provided for performing random access. The method comprises transmitting a Msg3 message to a network node, wherein the Msg3 message includes an indication of whether the wireless device is a reduced capability wireless device. Thus the network node, e.g. a base station such as an eNodeB or godeB, may receive an indication that the wireless device is (or is not) a reduced capability (e.g. RedCap) device and may act accordingly. For example, the network node may decide to grant access to a cell or refuse access based on the indication and also in some examples based on the wireless device's intended use of any granted resources, such as for example indicated in an EstablishmentCause in the Msg3 message.

In some examples, the Msg3 message includes an Information Element (IE) that indicates whether the wireless device is a reduced capability wireless device. For example, the Information Element may contain the indication of whether the wireless device is a reduced capability wireless device. The Information Element may in some examples be a new information element as compared to a legacy Msg3 message (where a legacy Msg3 message referred to herein is for example a Msg3 message according to a 3GPP standard earlier than a standard that specifies the Information Element). Thus, for example, a 3GPP standard earlier than the standard that specifies the Information Element may not specify the Information Element. In some examples, the size of the Msg3 message may be larger than the size of a legacy Msg3 message, for example to ensure that the Msg3 message is large enough to include the new Information Element (which may be included in the Msg3 message along with one or more other IEs in some examples).

Alternatively, in some examples, the Information Element type may be selected based on whether the wireless device is a reduced capability wireless device. That is, for example, the Information Element is a first type if the wireless device is a reduced capability wireless device, or a second type if the wireless device is not a reduced capability wireless device or is a legacy wireless device. Thus, for example, the Msg3 message may include one type of IE, or the other type of IE, but not both, and which one is included indicates whether the wireless device is a reduced capability wireless device.

In some examples, the Msg3 message includes a Msg3 bit that indicates whether the wireless device is a reduced capability wireless device. For example, the Msg3 bit may be set to a first value if the wireless device is a reduced capability wireless device, or a second value (different to the first value) if the wireless device is not a reduced capability wireless device or is a legacy wireless device. In some examples, the Msg3 bit is a spare bit in a legacy Msg3 message. That is, for example, it is a currently unused bit or a bit that is specified as being unused, reserved or spare in a 3GPP specification earlier than a specification that specifies the Msg3 bit.

In some examples, the Msg3 message includes a Medium Access Control (MAC) Control Element (MAC CE) that indicates whether the wireless device is a reduced capability wireless device. For example, the Msg3 message is contained within a MAC SDU or PDU that includes a header with the MAC CE. The MAC CE may for example include a MAC CE bit that indicates whether the wireless device is a reduced capability wireless device. For example, the MAC CE bit may be set to a first value if the wireless device is a reduced capability wireless device, or a second value (different to the first value) if the wireless device is not a reduced capability wireless device or is a legacy wireless device. In some examples, the MAC CE bit is a reserved bit in a legacy Msg3 message or a legacy MAC CE.

In some examples, the MAC CE includes a Logical Channel ID (LCID) or enhanced LCID (eLCID) that indicates whether the wireless device is a reduced capability wireless device. For example, the LCID or eLCID is one of a first plurality of values if the wireless device is a reduced capability wireless device, or a value other than the first plurality of values if the wireless device is not a reduced capability wireless device or is a legacy wireless device. Thus for example a range of LCID or eLCID values may indicate that the device is a reduced capability wireless device. The first plurality of values may be a plurality of reserved values in a legacy Msg3 message in some examples.

In some examples, the Msg3 message indicates an establishment cause (EstablishmentCause) that indicates whether the wireless device is a reduced capability wireless device. In some examples, the establishment cause may be a cause that is one of a plurality of causes specific to reduced capability devices, and hence the use of the cause by the device indicates that the device is a reduced capability device. In some examples, the establishment cause is a spare establishment cause in a legacy Msg3 message (e.g. the establishment cause has a value that was previously unused, reserved or spare). The establishment cause may be for example one of a first plurality of establishment causes when the wireless device is a reduced capability wireless device, and one of a second plurality of establishment causes (different to the first plurality of causes, e.g. there is no overlap) if the wireless device is not a reduced capability wireless device or is a legacy wireless device.

In some examples, the Msg3 message may be transmitted on an uplink common control channel 1 (UL CCCH1). In such examples, a MessageType or MessageClassExtension in the Msg3 message may be used to indicate whether the wireless device is a reduced capability wireless device. Alternatively, in some examples, the Msg3 message may be transmitted on an uplink common control channel 2 (UL CCCH2). In such examples, a message class of the Msg3 message may be used to indicate whether the wireless device is a reduced capability wireless device. For example, a particular value or one of a plurality of particular values of the MessageType, MessageClassExtension or message class may be used to indicate that the device is a reduced capability wireless device, and is not such a device if another value is used.

In some examples, the Msg3 message indicates a User Equipment ID (UE ID) of the wireless device (e.g. as part of a random access procedure), and wherein the UE ID indicates whether the wireless device is a reduced capability wireless device. For example, the UE ID is one of a first plurality of values (e.g. a first range) if the wireless device is a reduced capability wireless device, or a value other than the first plurality of values (e.g. outside the first range) if the wireless device is not a reduced capability wireless device or is a legacy wireless device.

The wireless device may for example comprises a User Equipment (UE). In some examples, the Msg3 message includes an indication of whether the wireless device is a reduced capability wireless device according to 3GPP Release 17 (any version), or any later 3GPP Release.

In some examples, the Msg3 message comprises one of a RRCSetupRequest message, RRCResumeRequest message, RRCResumeRequest1 message, and RRC Connection Request message.

The Msg3 may in some examples be sent in response to receiving a Msg2 message or Random Access Response (RAR) message from the network node, which itself may be received in response to the wireless device sending a Msg1 message to the network node.

In some examples, the method may comprise receiving a further message from the network node, wherein the further message is based at least on the indication of whether the wireless device is a reduced capability wireless device. For example, the further message may comprise a RRCSetup or RRCReject message based on the indication of whether the wireless device is a reduced capability wireless device. The further message received may be further based on an establishment cause (EstablishmentCause) indicated in the Msg3 message. For example, the network may not allow certain establishment causes such as video calls for reduced capability devices, and thus may reject random access for such establishment causes from reduced capability devices.

Another aspect of this disclosure provides a method performed by a network node (e.g. base station, gNodeB or eNodeB) for random access. The method comprises receiving a Msg3 message from a wireless device, wherein the Msg3 message includes an indication of whether the wireless device is a reduced capability wireless device. In some examples, the Msg3 message may take any suitable format such as the formats or examples described above. In some examples, the wireless device may perform a method as described herein.

Particular example embodiments will now be described. Some embodiments are described in the context of 5G/NR, whereas such examples may also be applied to other wireless communication technologies including 4G/LTE, with components replaced in some examples with equivalents as appropriate (e.g. gNB replaced by eNB in a 4G/LTE implementation, etc.).

Option 1: Use a Spare Bit in RRC Message(s)

In one embodiment, the RedCap capability is indicated by using one spare bit of the RRCSetupRequest, RRCResumeRequest, or RRCResumeRequest1 message over CCCH or CCCH1 included in the Msg3 transmission. In one example, illustrated in the example ASN.1 code shown below, in Msg3 RRCSetupRequest message if the spare bit is set to ‘1’, it indicates the transmission comes from a RedCap UE (rUE). Otherwise, it represents a legacy NR UE (nUE).

If the spare bit value would be set to ‘1’, the rest of the message contents would be interpreted as associated with a RedCap UE and a RedCap use case. For example, when the spare is ‘1’ and mo-VoiceCall is signaled in EstablishmentCause, the network would understand that a RedCap UE is trying to establish a voice call. Depending on the network configuration and operator preference, such an establishment attempt may be further either accepted or rejected by the network. A corresponding determination by the gNB/network would be done with other establishment causes. With this re-interpretation of information elements, if the spare bit is set to ‘1’, establishment causes not relevant for RedCap use cases, e.g., mo-VideoCall or mps-PriorityAccess could instead be mapped to new RedCap-specific establishment causes.

In another embodiment, the RedCap capabilities can be indicated using the EstablishmentCause of RRCSetupRequest. For instance, but not limited to, the spare values of the EstablishmentCause can be defined as different Redcap establishment causes. Example ASN.1 code shown below illustrates the establishment causes where RedCap signalling, data, video, and SMS services are defined as RC-Signalling, RC-Data, RV-VideoCall, RC-SMS establishment causes, respectively.

In one implementation of this embodiment, the establishment causes which are specific to RedCap UEs would map to intended use cases of rUEs, such as (not limiting) video monitoring, wearable or industrial wireless sensor. In such a case, the network could decide based on the requested use case whether the UE's request is accepted or rejected.

The below ASN.1 code shows an example of a Msg3 RedCap Indication in RRCSetupRequest using a spare bit.

RRCSetupRequest message

| -- ASN1START | |
|---|---|
| -- TAG-RRCSETUPREQUEST-START | |
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1)) |
| } | |
| InitialUE-Identity ::= | CHOICE { |
| ng-5G-S-TMSI-Part1 | BIT STRING (SIZE (39)), |
| randomValue | BIT STRING (SIZE (39)) |
| } | |
| EstablishmentCause ::= | ENUMERATED { |
| | emergency, highPriorityAccess, |
| mt-Access, mo-Signalling, | |
| | mo-Data, mo-VoiceCall, mo- |
| VideoCall, mo-SMS, mps-PriorityAccess, mcs-PriorityAccess, | |
| | spare6, spare5, spare4, spare3, |
| spare2, spare1} | |
| -- TAG-RRCSETUPREQUEST-STOP | |
| -- ASN1STOP | |

The below ASN.1 code shows an example of a Msg3 RedCap Indication in EstablishmentCause of RRCSetupRequest.

RRCSetupRequest message

| -- ASN1START | |
|---|---|
| -- TAG-RRCSETUPREQUEST-START | |
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1)) |
| } | |
| InitialUE-Identity ::= | CHOICE { |
| ng-5G-S-TMSI-Part1 | BIT STRING (SIZE (39)), |
| randomValue | BIT STRING (SIZE (39)) |
| } | |
| EstablishmentCause ::= | ENUMERATED { |
| | emergency, highPriorityAccess, |
| mt-Access, mo-Signalling, | |
| | mo-Data, mo-VoiceCall, mo- |

VideoCall, mo-SMS, mps-PriorityAccess, mcs-PriorityAccess,

RC-Signalling, RC-Data, RC-

VideoCall, RC-SMS, spare2, spare1}
-- TAG-RRCSETUPREQUEST-STOP
-- ASN1STOP

Option 2: New Larger RRC Message, Eq. RRCSetupRequestRedcap

In another example embodiment, a new IE could be defined for RRCSetupRequest, RRCResumeRequest, and RRCResumeRequest1. The new IE has at least 1 extra bit of information. In one example, illustrated in the example ASN.1 code shown below, a new IE, RRCSetupRequestRedCap-les, is defined. In the IE a new UE type indication of 1 bit UEType is defined.

The below ASN.1 code shows an example of a new IE type RRCSetupRequestRedCap-les.

RRCSetupRequest message

-- ASN1START
-- TAG-RRCSETUPREQUEST-START

| | |
|---|---|
| RRCSetupRequest ::= | SEQUENCE { |
| rrcSetupRequest | RRCSetupRequest-Ies |
| rrcSetupRequestRedCap | RRCSetupRequestRedCap-Ies |
| } | |
| RRCSetupRequestRedCap-IEs ::= | SEQUENCE { |
| ue-Identity | InitialUE-Identity, |
| establishmentCause | EstablishmentCause, |
| UEType | BIT STRING (SIZE (1)) |
| } | |
| -- TAG-RRCSETUPREQUEST-STOP | |
| -- ASN1STOP | |

In another example embodiment, a new message(s) could be defined and inside the message have options for NR and Redcap NR. In this case, RRC Setup Request IEs are defined separately both for NR and RedCap NR solutions. The example ASN.1 code shown below illustrates an example, where the RRCSetupRequestRedCapNR provides a CHOICE sequence to select from. In an additional embodiment, the message can be defined separately to have two parallel IEs for two systems, i.e., NR and NR-Redcap, and any other future solutions.

The below ASN.1 code shows an example of a new IE type RRCSetupRequestRedCap-IEs.

RRCSetupRequest message

-- ASN1START
-- TAG-RRCSETUPREQUEST-START

| | |
|---|---|
| RRCSetupRequestRedCapNR ::= | CHOICE { |
| rrcSetupRequest | RRCSetupRequest-Ies |
| rrcSetupRequestRedCap | RRCSetupRequestRedCap-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1)) |
| } | |
| RRCSetupRequestRedCap-IEs ::= | SEQUENCE { |
| ue-Identity | InitialUE-Identity, |
| establishmentCause | EstablishmentCause, |
| UEType | BIT STRING (SIZE (1)) |
| } | |
| InitialUE-RedCap-Identity ::= | CHOICE { |
| ng-5G-S-TMSI-Part1 | BIT STRING (SIZE |
| (39)), | |
| randomValue | BIT STRING (SIZE (39)) |
| } | |

-- TAG-RRCSETUPREQUEST-STOP
-- ASN1STOP

Option 3: MAC CE

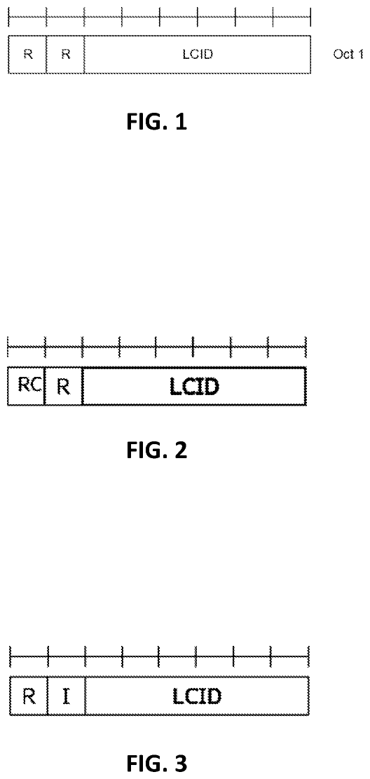

In an alternative example embodiment, an existing MAC CE can be used to indicate a RedCap device. The MAC Subheader for a MAC SDU containing UL CCCH consists of the two reserved header fields in R/LCID, as illustrated in FIG. 1, which shows an example of a MAC subheader. One can use one of the reserved bits to indicate RC/R/LCID. An example is illustrated in the example MAC subheader shown in FIG. 2, where one of the reserved bits is used for the RedCap Indication, illustrated as RC. Another example is illustrated in the example MAC subheader shown in FIG. 3, where one of the reserved bits are used in a format as R/I/LCID, where/is the RedCap/NR indicator.

In another example embodiment, LCID can be used to indicate the RedCap indication. In 38.321 Table 6.2.1-2, 35-44 index is reserved. Out of the reserved bits, two bits can be assigned to indicate RedCap CCCH indication as illustrated in the table below (Table 6.2.1-2 of 38.321), but not limited to this example.

| Codepoint/ | |
|---|---|
| Index | LCID values |
| 0 | CCCH of size 64 bits (referred to as “CCCH1” in TS |
| | 38.331 [5]) |
| 1-32 | Identity of the logical channel |
| 33 | Extended logical channel ID field (two-octet eLCID field) |
| 34 | Extended logical channel ID field (one-octet eLCID field) |
| 35 | CCCH of size 64 bits with RedCap (referred to as |
| | “CCCH1” in TS 38.331 [5]) |
| 36-43 | Reserved |
| 44 | CCCH of size 48 bits with RedCap (referred to as |
| | “CCCH” in TS 38.331 [5]) |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in TS |
| | 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

In an additional example embodiment, eLCID could be used to indicate the RedCap indication. Table 6.2.1-2b of 38.321 has 0-249 reserved codepoints. As illustrated in Table 2 Some of these code points can be used to define RedCap capabilities. To exemplify, the table below (example values of one-octet eLCID for UL-SCH) illustrates that 1 codepoint 249 and index 313 is used to signal RedCap Configured Grant confirmation.

| Codepoint | Index | LCID values |
|---|---|---|
| 0 to 249 | 64 to 312 | Reserved |
| 249 | 313 | RedCap Configured Grant Confirmation |
| 250 | 314 | BFR (four octets Cᵢ) |
| 251 | 315 | Truncated BFR (four octets Cᵢ) |
| 252 | 316 | Multiple Entry Configured Grant Confirmation |
| 253 | 317 | Sidelink Configured Grant Confirmation |
| 254 | 318 | Desired Guard Symbols |
| 255 | 319 | Pre-emptive BSR |

Option 4: Using Existing IE

In an alternative example embodiment, the RedCap UE type is deduced from the UE_ID, e.g., from the InitialUE-Identity. The UE_ID space is partitioned such that gNB can deduct from the UE_ID if the UE is of RedCap type (UE_ID belongs to RedCap partition) or not. In practice a certain value range for InitialUE-Identity (in RRCSetupRequest), ShortI-RNTI-Value (in RRCResumeRequest), I-RNTI-Value (in RRCResumeRequest1) is devoted to RedCap UEs.

The InitialUE-Identity can either be an initial part of the 5G-S-TMSI value, or a random value, which would then be partitioned as outlined above. An example of the format of InitialUE-Identity is provided below:

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

Legacy UEs may not be able to understand this new functionality. For the 5G-S-TMSI and the two different I-RNTIs the network can re-assign TMSI and I-RNTI values to legacy UEs in the field to make this embodiment work. However, legacy UEs would not understand that the entire randomValue should not be used, so in this case, the RedCap indication in Msg3 would be possible in initial attach to the network (which may not be required either).

Option 5: RA Procedure for Transmitting a New, Larger UL-CCCH Message to Indicate RedCap Using Preamble Group B

In another example embodiment, a new RRC message to be transmitted on UL-CCCH/UL-CCCH1 is defined to indicate a RedCap UE. In legacy RA, the grant size for msg3 is typically set to a minimum value to enable transmission of the legacy RRCSetup or RRCResumeRequest message. The reason for imposing a minimum grant is to enhance coverage. In case a preamble groupB is configured, UEs with potential Msg3 size (UL data available for transmission plus MAC header and, where required, MAC CEs) greater than ra-Msg3SizeGroupA select this preamble group. The parameter is used to distribute UEs between the two preamble groups for load balancing purposes.

In this embodiment, it is proposed that:
a. If only preamble groupA is configured->NW always gives a grant which can transmit the RedCap msg3.
b. If Preamble group B is configured, the legacy UEs select this group if msg3 size is greater than ra-Msg3SizeGroupA. Options for RedCap UEs are then:
   a. ra-Msg3SizeGroupA is used to put RedCap UEs to preamble groupB. This option allowing a minimum grant size for group A to give best possible coverage for legacy UEs sending RRCSetup/RRCResumeRequest. This option would then not do a good job of distributing legacy UEs between the groups since all UEs with data would end up in group B.
   b. A new indicator (RRC configured parameter) is introduced to indicate if Redcap UEs should use preamble groupA (large enough grant for redcap msg3) or groupB. The ra-Msg3SizeGroupA could then be used as in legacy to distribute legacy UEs between the groups, in order to achieve a good load balance between the preamble groups.

Option 6: UL-CCCH1 and/or messageClassExtension

In an alternative embodiment, the Msg3 RedCap Indication of UL-CCCH1-MessageType spare choices could be used to define a new message which is to be used by RedCap devices. To exemplify, but not limited to, UL-CCCH1-Message choice could be defined as rrcSetupRequestRedCap, as illustrated in the example ASN.1 code shown below, where default RRCSetupRequestRedcap is used to signal RedCap indication. In this case other spare choices are available for future implementation.

| -- ASN1START | |
|---|---|
| -- TAG-UL-CCCH1-MESSAGE-START | |
| UL-CCCH1-Message ::= | SEQUENCE { |
| message | UL-CCCH1-MessageType |
| } | |
| UL-CCCH1-MessageType ::= | CHOICE { |
| c1 | CHOICE { |
| rrcResumeRequest1 | RRCResumeRequest1, |
| rrcSetupRequestRedCap | RRCSetupRequestRedCap, |
| spare2 | NULL, |
| spare1 | NULL |
| }, | |
| messageClassExtension SEQUECE { } | |
| } | |

-- TAG-UL-CCCH1-MESSAGE-STOP

In an additional example embodiment, UL-CCCH1-MessageType with RRCSetupRequest with 48-bits RRC messages can be used to indicate RedCap capabilities. As the UL-CCCH1 is used with a small RRC message size, the UE can identify the RedCap capability with a short RRCSetupRequest message where UL-CCCH1-Message class is the set of 64-bits RRC messages.

In another example embodiment, UL-CCCH with messageClassExtension can be used with choice C2 defined to indicate RedCap. In the following example ASN.1 code, which shows an example of defining a new choice class for UL-CCCH using messageClassExtension, messageClassExtension can be used with new defined choice C2 to indicate RedCap.

| | |
|---|---|
| UL-CCCH-Message ::= | SEQUENCE { |
| message | UL-CCCH-MessageType |
| } | |
| UL-CCCH-MessageType ::= | CHOICE { |
| c1 | CHOICE { |
| rrcSetupRequest | RRCSetupRequest, |
| rrcResumeRequest | RRCResumeRequest, |
| rrcReestablishmentRequest | RRCReestablishmentRequest, |
| rrcSystemInfoRequest | RRCSystemInfoRequest |
| }, | |
| messageClass Extension::= | CHOICE { |
| c2 | CHOICE { |
| rrcSetupRequest | RRCSetupRequest, |
| rrcResumeRequest | RRCResumeRequest, |
| } | |
| } | |

In an additional example embodiment, a new UL-CCCH message class could be defined to indicate the RedCap capability. As illustrated in the example ASN.1 code shown below, the UL-CCCH2-Message is defined to indicate the RedCap message.

-- ASN1START
-- TAG-UL-CCCH2-MESSAGE-START

| | |
|---|---|
| UL-CCCH2-Message ::= | SEQUENCE { |
| message | UL-CCCH2-MessageType |
| } | |
| UL-CCCH2-MessageType ::= | CHOICE { |
| c1 | CHOICE { |
| rrcSetupRequestRedCap | RRCSetupRequestRedCap, |
| rrcResumeRequestRedCap | RRCResumeRequestRedCap, |
| rrcReestablishmentRequestRedCap | |
| RRCReestablishmentRequestRedCap, | |
| rrcSystemInfoRequestRedCap | RRCSystemInfoRequestRedCap |
| }, | |
| messageClassExtension SEQUENCE { } | |
| } | |

-- TAG-UL-CCCH1-MESSAGE-STOP
-- ASN1STOP

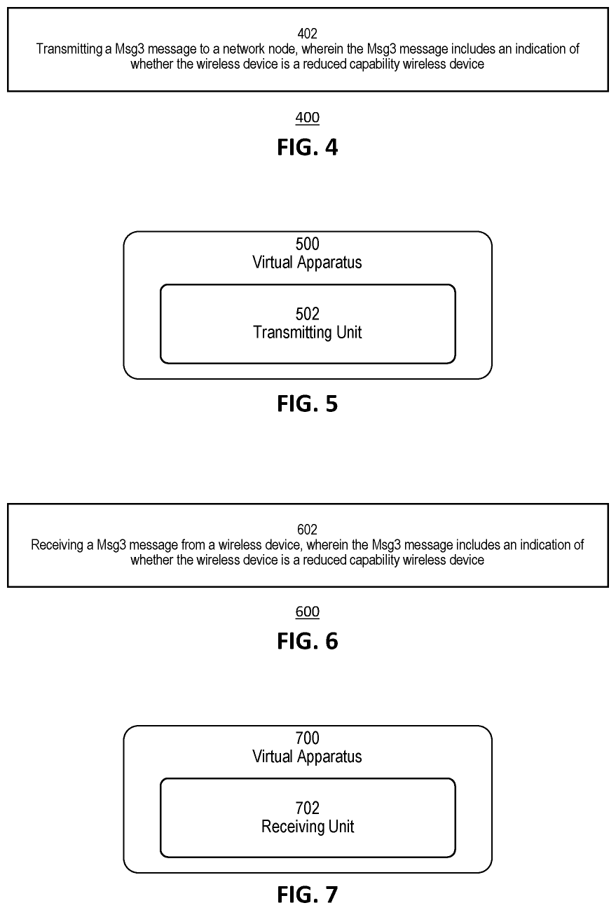

FIG. 4 depicts a method performed by a wireless device for performing random access in accordance with particular embodiments. The method begins at step 402 with transmitting a Msg3 message to a network node, wherein the Msg3 message includes an indication of whether the wireless device is a reduced capability wireless device.

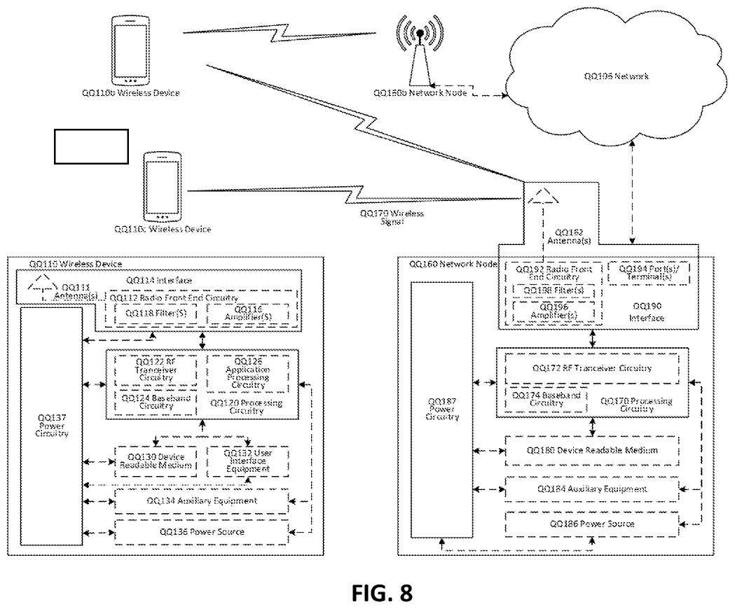

FIG. 5 illustrates a schematic block diagram of an apparatus 500 for performing random access in a wireless network (for example, the wireless network shown in FIG. 8). The apparatus may be implemented in a wireless device or network node (e.g., wireless device QQ110 or network node QQ160 shown in FIG. 8). Apparatus 500 is operable to carry out the example method described with reference to FIG. 4 and possibly any other processes or methods disclosed herein. It is also to be understood that the method of FIG. 4 is not necessarily carried out solely by apparatus 500. At least some operations of the method can be performed by one or more other entities.

Virtual Apparatus 500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 502, and any other suitable units of apparatus 500 to perform corresponding functions according one or more embodiments of the present disclosure.

As illustrated in FIG. 5, apparatus 500 includes transmitting unit 502 configured to transmit a Msg3 message to a network node, wherein the Msg3 message includes an indication of whether the wireless device is a reduced capability wireless device.

FIG. 6 depicts a method performed by a network node for random access in accordance with particular embodiments, the method begins at step 602 with receiving a Msg3 message from a wireless device, wherein the Msg3 message includes an indication of whether the wireless device is a reduced capability wireless device.

FIG. 7 illustrates a schematic block diagram of an apparatus 700 for performing random access in a wireless network (for example, the wireless network shown in FIG. 8). The apparatus may be implemented in a wireless device or network node (e.g., wireless device QQ110 or network node QQ160 shown in FIG. 8). Apparatus 700 is operable to carry out the example method described with reference to FIG. 6 and possibly any other processes or methods disclosed herein. It is also to be understood that the method of FIG. 6 is not necessarily carried out solely by apparatus 700. At least some operations of the method can be performed by one or more other entities.

Virtual Apparatus 700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 702, and any other suitable units of apparatus 700 to perform corresponding functions according one or more embodiments of the present disclosure.

As illustrated in FIG. 7, apparatus 700 includes receiving unit 702 configured to receive a Msg3 message from a wireless device, wherein the Msg3 message includes an indication of whether the wireless device is a reduced capability wireless device.

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network QQ106, network nodes QQ160 and QQ160b, and WDs QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 8 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

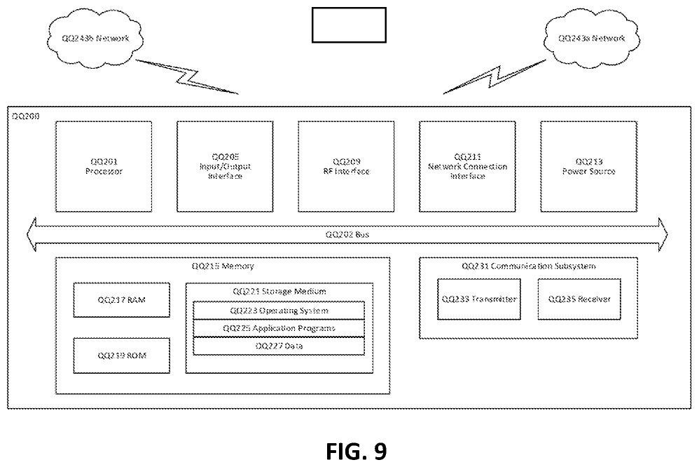

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ200 may be any UE identified by the 3^{rd} Generation Partnership Project (3GPP), including a NB-IoT UE, a machine type communication (MTC) UE, and/or an enhanced MTC (eMTC) UE. UE QQ200, as illustrated in FIG. 9, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 9, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

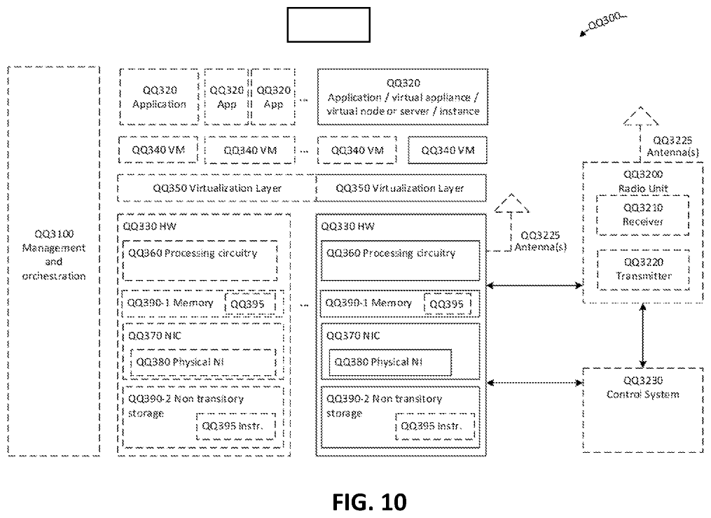

FIG. 10 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 10, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 10.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

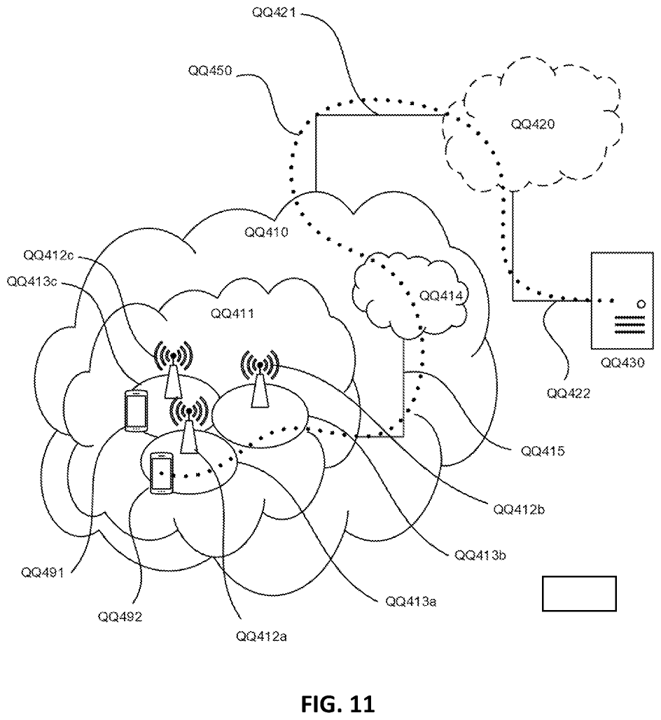

With reference to FIG. 11, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 11 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

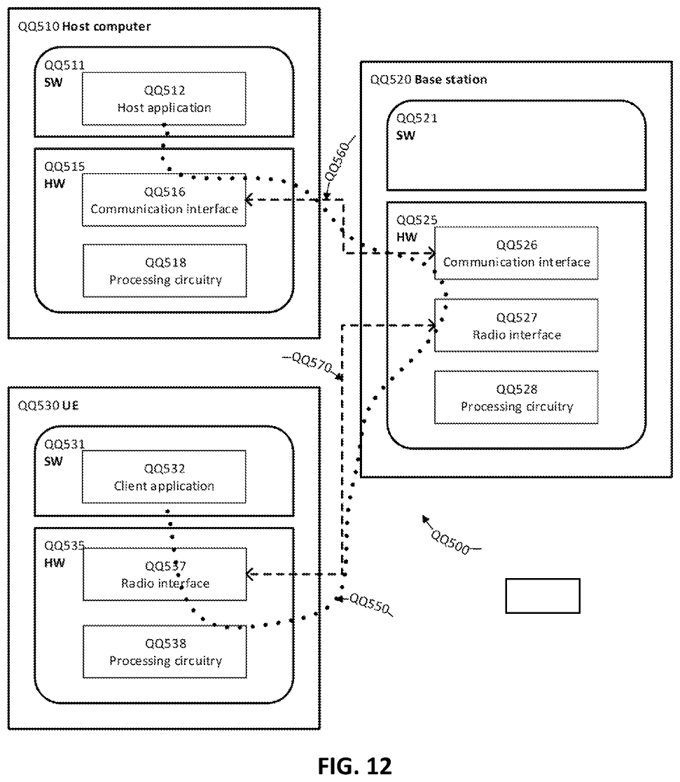

Example implementations, in accordance with an embodiment, of the UE, base station and host computer discussed in the preceding paragraphs will now be described with reference to FIG. 12. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 12) served by base station QQ520. Communication interface QQ526 may be configured to facilitate connection QQ560 to host computer QQ510. Connection QQ560 may be direct or it may pass through a core network (not shown in FIG. 12) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 12 may be similar or identical to host computer QQ430, one of base stations QQ412a, QQ412b, QQ412c and one of UEs QQ491, QQ492 of FIG. 11, respectively. This is to say, the inner workings of these entities may be as shown in FIG. 12 and independently, the surrounding network topology may be that of FIG. 11.

In FIG. 12, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may improve the range of features and functionalities provided by a network and thereby provide benefits such as flexibility, spectrum efficiency etc.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

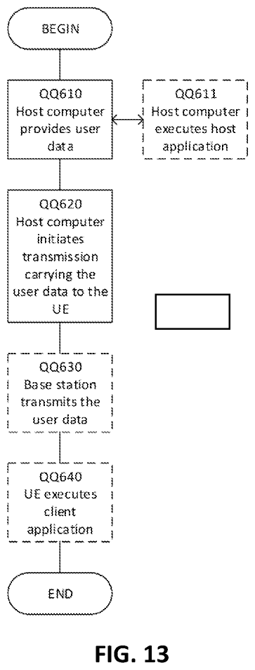

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

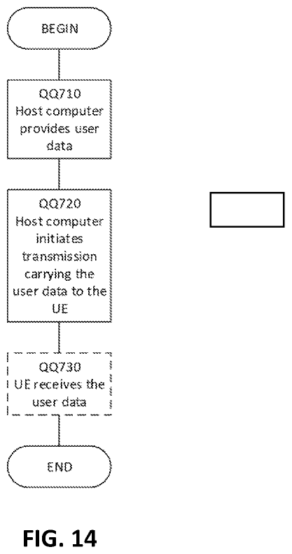

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

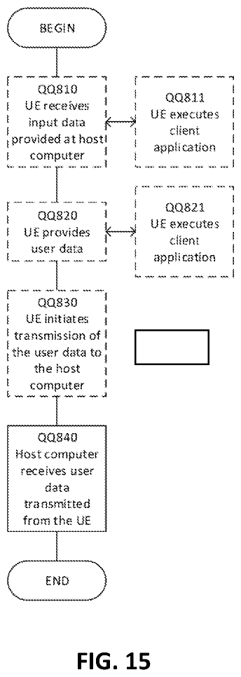

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

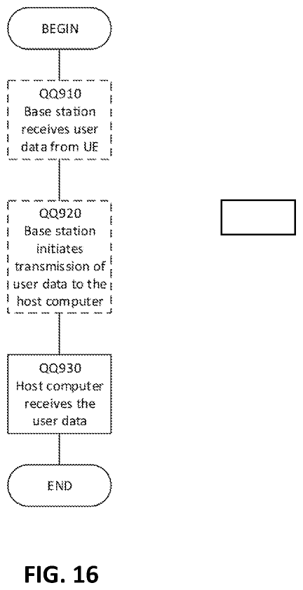

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station. The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The following enumerated embodiments are also provided:

### Group A Embodiments

1. A method performed by a wireless device for performing random access, the method comprising:
transmitting a Msg3 message to a network node, wherein the Msg3 message includes an indication of whether the wireless device is a reduced capability wireless device.

2. The method of embodiment 1, wherein the Msg3 message includes an Information Element (IE) that indicates whether the wireless device is a reduced capability wireless device.

3. The method of embodiment 2, wherein the Information Element contains the indication of whether the wireless device is a reduced capability wireless device.

4. The method of embodiment 3, wherein the Information Element is a new information element as compared to a legacy Msg3 message.

5. The method of embodiment 3 or 4, wherein the size of the Msg3 message is larger than the size of a legacy Msg3 message.

6. The method of embodiment 2, wherein the Information Element type is selected based on whether the wireless device is a reduced capability wireless device.

7. The method of embodiment 6, wherein the Information Element is a first type if the wireless device is a reduced capability wireless device, or a second type if the wireless device is not a reduced capability wireless device or is a legacy wireless device.

8. The method of any of embodiments 1 to 7, wherein the Msg3 message includes a Msg3 bit that indicates whether the wireless device is a reduced capability wireless device.

9. The method of embodiment 8, wherein the Msg3 bit is set to a first value if the wireless device is a reduced capability wireless device, or a second value if the wireless device is not a reduced capability wireless device or is a legacy wireless device.

10. The method of embodiment 8 or 9, wherein the Msg3 bit is a spare bit in a legacy Msg3 message.

11. The method of any of embodiments 1 to 10, wherein the Msg3 message includes a Medium Access Control Control Element (MAC CE) that indicates whether the wireless device is a reduced capability wireless device.

12. The method of embodiment 11, wherein the MAC CE includes a MAC CE bit that indicates whether the wireless device is a reduced capability wireless device.

13. The method of embodiment 12, wherein the MAC CE bit is set to a first value if the wireless device is a reduced capability wireless device, or a second value if the wireless device is not a reduced capability wireless device or is a legacy wireless device.

14. The method of embodiment 12 or 13, wherein the MAC CE bit is a reserved bit in a legacy Msg3 message.

15. The method of any of embodiments 11 to 14, wherein the MAC CE includes a Logical Channel ID (LCID) or enhanced LCID (eLCID) that indicates whether the wireless device is a reduced capability wireless device.

16. The method of embodiment 15, wherein the LCID or eLCID is one of a first plurality of values if the wireless device is a reduced capability wireless device, or a value other than the first plurality of values if the wireless device is not a reduced capability wireless device or is a legacy wireless device.

17. The method of embodiment 16, wherein the first plurality of values comprises a plurality of reserved values in a legacy Msg3 message.

18. The method of any of embodiments 1 to 17, wherein the Msg3 message indicates an establishment cause (EstablishmentCause) that indicates whether the wireless device is a reduced capability wireless device.

19. The method of embodiment 18, wherein the establishment cause is a spare establishment cause in a legacy Msg3 message.

20. The method of embodiment 18 or 19, wherein the establishment cause is one of a first plurality of establishment causes when the wireless device is a reduced capability wireless device, or one of a second plurality of establishment causes if the wireless device is not a reduced capability wireless device or is a legacy wireless device.

21. The method of any of embodiments 1 to 20, wherein the Msg3 message is transmitted on an uplink common control channel 1 (UL CCCH1), and a MessageType or MessageClassExtension in the Msg3 message indicates whether the wireless device is a reduced capability wireless device.

22. The method of any of embodiments 1 to 20, wherein the Msg3 message is transmitted on an uplink common control channel 2 (UL CCCH2), and wherein a message class of the Msg3 message indicates whether the wireless device is a reduced capability wireless device.

23. The method of any of embodiments 1 to 22, wherein the Msg3 message indicates a User Equipment ID (UE ID) of the wireless device, and wherein the UE ID indicates whether the wireless device is a reduced capability wireless device.

24. The method of embodiment 23, wherein the UE ID is one of a first plurality of values if the wireless device is a reduced capability wireless device, or a value other than the first plurality of values if the wireless device is not a reduced capability wireless device or is a legacy wireless device.

25. The method of any of embodiments 1 to 24, wherein the wireless device comprises a User Equipment (UE).

26. The method of any of embodiments 1 to 25, wherein the network node comprises a base station, eNodeB or gNodeB.

27. The method of any of embodiments 1 to 26, wherein the Msg3 message includes an indication of whether the wireless device is a reduced capability wireless device according to 3GPP Release 17.

28. The method of any of embodiments 1 to 27, wherein the Msg3 message comprises one of a RRCSetupRequest message, RRCResumeRequest message, RRCResumeRequest1 message, and RRC Connection Request message.

29. The method of any of embodiments 1 to 28, wherein the Msg3 is sent in response to receiving a Msg2 message or Random Access Response (RAR) message from the network node.

30. The method of any of embodiments 1 to 29, comprising receiving a further message from the network node, wherein the further message is based at least on the indication of whether the wireless device is a reduced capability wireless device.

31. The method of embodiment 30, wherein the further message comprises a RRCSetup or RRCReject message based on the indication of whether the wireless device is a reduced capability wireless device.

32. The method of any of the previous embodiments, further comprising:
providing user data; and
forwarding the user data to a host computer via the transmission to the base station.

### Group B Embodiments

33. A method performed by a network node for random access, the method comprising:
receiving a Msg3 message from a wireless device, wherein the Msg3 message includes an indication of whether the wireless device is a reduced capability wireless device.

34. The method of embodiment 1, wherein the Msg3 message includes an Information Element (IE) that indicates whether the wireless device is a reduced capability wireless device.

35. The method of embodiment 2, wherein the Information Element contains the indication of whether the wireless device is a reduced capability wireless device.

36. The method of embodiment 3, wherein the Information Element is a new information element as compared to a legacy Msg3 message.

37. The method of embodiment 3 or 4, wherein the size of the Msg3 message is larger than the size of a legacy Msg3 message.

38. The method of embodiment 2, wherein the Information Element type is selected based on whether the wireless device is a reduced capability wireless device.

39. The method of embodiment 6, wherein the Information Element is a first type if the wireless device is a reduced capability wireless device, or a second type if the wireless device is not a reduced capability wireless device or is a legacy wireless device.

40. The method of any of embodiments 1 to 7, wherein the Msg3 message includes a Msg3 bit that indicates whether the wireless device is a reduced capability wireless device.

41. The method of embodiment 8, wherein the Msg3 bit is set to a first value if the wireless device is a reduced capability wireless device, or a second value if the wireless device is not a reduced capability wireless device or is a legacy wireless device.

42. The method of embodiment 8 or 9, wherein the Msg3 bit is a spare bit in a legacy Msg3 message.

43. The method of any of embodiments 1 to 10, wherein Msg3 message includes a Medium Access Control Control Element (MAC CE) that indicates whether the wireless device is a reduced capability wireless device.

44. The method of embodiment 11, wherein the MAC CE includes a MAC CE bit that indicates whether the wireless device is a reduced capability wireless device.

45. The method of embodiment 12, wherein the MAC CE bit is set to a first value if the wireless device is a reduced capability wireless device, or a second value if the wireless device is not a reduced capability wireless device or is a legacy wireless device.

46. The method of embodiment 12 or 13, wherein the MAC CE bit is a reserved bit in a legacy Msg3 message.

47. The method of any of embodiments 11 to 14, wherein the MAC CE includes a Logical Channel ID (LCID) or enhanced LCID (eLCID) that indicates whether the wireless device is a reduced capability wireless device

48. The method of embodiment 15, wherein the LCID or eLCID is one of a first plurality of values if the wireless device is a reduced capability wireless device, or a value other than the first plurality of values if the wireless device is not a reduced capability wireless device or is a legacy wireless device.

49. The method of embodiment 16, wherein the first plurality of values comprises a plurality of reserved values in a legacy Msg3 message.

50. The method of any of embodiments 1 to 17, wherein the Msg3 message indicates an establishment cause (EstablishmentCause) that indicates whether the wireless device is a reduced capability wireless device.

51. The method of embodiment 18, wherein the establishment cause is a spare establishment cause in a legacy Msg3 message.

52. The method of embodiment 18 or 19, wherein the establishment cause is one of a first plurality of establishment causes when the wireless device is a reduced capability wireless device, one of a second plurality of establishment causes if the wireless device is not a reduced capability wireless device or is a legacy wireless device.

53. The method of any of embodiments 1 to 20, wherein the Msg3 message is transmitted on an uplink common control channel 1 (UL CCCH1), and a MessageType or MessageClassExtension in the Msg3 message indicates whether the wireless device is a reduced capability wireless device.

54. The method of any of embodiments 1 to 20, wherein the Msg3 message is transmitted on an uplink common control channel 2 (UL CCCH2), and wherein a message class of the Msg3 message indicates whether the wireless device is a reduced capability wireless device.

55. The method of any of embodiments 1 to 22, wherein the Msg3 message indicates a User Equipment ID (UE ID) of the wireless device, and wherein the UE ID indicates whether the wireless device is a reduced capability wireless device.

56. The method of embodiment 23, wherein the UE ID is one of a first plurality of values if the wireless device is a reduced capability wireless device, or a value other than the first plurality of values if the wireless device is not a reduced capability wireless device or is a legacy wireless device.

57. The method of any of embodiments 1 to 24, wherein the wireless device comprises a User Equipment (UE).

58. The method of any of embodiments 1 to 25, wherein the network node comprises a base station, eNodeB or gNodeB.

59. The method of any of embodiments 1 to 26, wherein Msg3 message includes an indication of whether the wireless device is a reduced capability wireless device according to 3GPP Release 17.

60. The method of any of embodiments 1 to 27, wherein the Msg3 message comprises one of a RRCSetupRequest message, RRCResumeRequest message, RRCResumeRequest1 message, and RRC Connection Request message.

61. The method of any of embodiments 1 to 28, wherein the Msg3 is received in response to sending a Msg2 message or Random Access Response (RAR) message to the wireless device.

62. The method of any of embodiments 1 to 29, comprising sending a further message to the wireless device, wherein the further message is based at least on the indication of whether the wireless device is a reduced capability wireless device.

63. The method of embodiment 30, wherein the further message comprises a RRCSetup or RRCReject message based on the indication of whether the wireless device is a reduced capability wireless device.

64. The method of embodiment 62 or 63, wherein the further message is based further on an establishment cause (EstablishmentCause) indicated in the Msg3 message.

65. The method of any of the previous embodiments, further comprising:
obtaining user data; and
forwarding the user data to a host computer or a wireless device.

### Group C Embodiments

66. A wireless device for performing random access, the wireless device comprising:
processing circuitry configured to perform any of the steps of any of the Group A embodiments; and
power supply circuitry configured to supply power to the wireless device.

67. A base station for random access, the base station comprising:
processing circuitry configured to perform any of the steps of any of the Group B embodiments;
power supply circuitry configured to supply power to the base station.

68. A user equipment (UE) for performing random access, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

69. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

70. The communication system of the previous embodiment further including the base station.

71. The communication system of the previous 2 embodiments, further including the UE, wherein the UE is configured to communicate with the base station.

72. The communication system of the previous 3 embodiments, wherein:
the processing circuitry of the host computer is configured to execute a host application, thereby providing the user data; and
the UE comprises processing circuitry configured to execute a client application associated with the host application.

73. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

74. The method of the previous embodiment, further comprising, at the base station, transmitting the user data.

75. The method of the previous 2 embodiments, wherein the user data is provided at the host computer by executing a host application, the method further comprising, at the UE, executing a client application associated with the host application.

76. A user equipment (UE) configured to communicate with a base station, the UE comprising a radio interface and processing circuitry configured to performs the of the previous 3 embodiments.

77. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

78. The communication system of the previous embodiment, wherein the cellular network further includes a base station configured to communicate with the UE.

79. The communication system of the previous 2 embodiments, wherein:
the processing circuitry of the host computer is configured to execute a host application, thereby providing the user data; and
the UE's processing circuitry is configured to execute a client application associated with the host application.

80. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

81. The method of the previous embodiment, further comprising at the UE, receiving the user data from the base station.

82. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

83. The communication system of the previous embodiment, further including the UE.

84. The communication system of the previous 2 embodiments, further including the base station, wherein the base station comprises a radio interface configured to communicate with the UE and a communication interface configured to forward to the host computer the user data carried by a transmission from the UE to the base station.

85. The communication system of the previous 3 embodiments, wherein:
the processing circuitry of the host computer is configured to execute a host application; and
the UE's processing circuitry is configured to execute a client application associated with the host application, thereby providing the user data.

86. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

87. A method implemented in a communication system including a host computer, a base station and a user equipment (UE), the method comprising:
at the host computer, receiving user data transmitted to the base station from the UE, wherein the UE performs any of the steps of any of the Group A embodiments.

88. The method of the previous embodiment, further comprising, at the UE, providing the user data to the base station.

89. The method of the previous 2 embodiments, further comprising:
at the UE, executing a client application, thereby providing the user data to be transmitted; and
at the host computer, executing a host application associated with the client application.

90. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

91. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

92. The communication system of the previous embodiment further including the base station.

93. The communication system of the previous 2 embodiments, further including the UE, wherein the UE is configured to communicate with the base station.

94. The communication system of the previous 3 embodiments, wherein:
the processing circuitry of the host computer is configured to execute a host application;
the UE is configured to execute a client application associated with the host application, thereby providing the user data to be received by the host computer.

95. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

96. The method of the previous embodiment, further comprising at the base station, receiving the user data from the UE.

97. The method of the previous 2 embodiments, further comprising at the base station, initiating a transmission of the received user data to the host computer.

### REFERENCES

1. RP-202933, New WID on support of reduced capability NR devices. Ericsson, Nokia, 3GPP TSG RAN Meeting #90e. December 2020.
2. RP-201677, Revised SID on Study on support of reduced capability NR devices, Ericsson, 3GPP TSG RAN Meeting #89e, September 2020.
3. 3GPP, TS 38.331, “Radio Resource Control (RRC) protocol specification”; v16.1.0, July 2020.
4. 3GPP, TS 38.321, “NR Medium Access Control (MAC) protocol specification”, v16.1.0, July 2020.
5. 3GPP, TS 38.304, “User Equipment (UE) procedures in Idle mode and RRC Inactive state”; v16.1.0, July 2020.
6. 3GPP, TS 38.213, “Physical layer procedures for control”; v16.3.0, September 2020.

1-40. (canceled)

41. A method performed by a wireless device for performing random access, the method comprising:
transmitting a Msg3 message to a network node of a wireless network, wherein the Msg3 message includes an indication of whether the wireless device is a reduced capability wireless device.

42. The method of claim 41, wherein the Msg3 message includes an Information Element (IE) that indicates whether the wireless device is a reduced capability wireless device, wherein the IE contains the indication of whether the wireless device is a reduced capability wireless device or wherein a type of the IE is selected based on whether the wireless device is a reduced capability wireless device.

43. The method of claim 42, wherein at least one of the following applies: the IE is a new information element as compared to a legacy Msg3 message; or the size of the Msg3 message is larger than the size of a legacy Msg3 message.

44. The method of claim 41, wherein the indication is a Msg3 bit that indicates whether the wireless device is a reduced capability wireless device.

45. The method of claim 41, wherein the Msg3 message includes a Medium Access Control Control Element (MAC CE) that indicates whether the wireless device is a reduced capability wireless device.

46. The method of claim 45, wherein the MAC CE includes a MAC CE bit that indicates whether the wireless device is a reduced capability wireless device.

47. The method of claim 45, wherein the MAC CE includes a Logical Channel ID (LCID) or enhanced LCID (eLCID) that indicates whether the wireless device is a reduced capability wireless device.

48. The method of claim 47, wherein the LCID or eLCID is one of a first plurality of values if the wireless device is a reduced capability wireless device, or a value other than the first plurality of values if the wireless device is not a reduced capability wireless device or is a legacy wireless device, wherein the first plurality of values comprises a plurality of reserved values in a legacy Msg3 message.

49. The method of claim 41, wherein the Msg3 message indicates an establishment cause (EstablishmentCause) that indicates whether the wireless device is a reduced capability wireless device.

50. The method of claim 41, wherein:
the Msg3 message is transmitted on an uplink common control channel 1 (UL CCCH1), and a MessageType or MessageClassExtension in the Msg3 message indicates whether the wireless device is a reduced capability wireless device; or
the Msg3 message is transmitted on an uplink common control channel 2 (UL CCCH2), and wherein a message class of the Msg3 message indicates whether the wireless device is a reduced capability wireless device.

51. The method of claim 41, wherein the Msg3 message indicates a User Equipment ID (UE ID) of the wireless device, and wherein the UE ID indicates whether the wireless device is a reduced capability wireless device.

52. The method of claim 41, wherein the wireless device comprises a User Equipment (UE) and the network node comprises a base station.

53. The method of claim 41, wherein the Msg3 message includes an indication of whether the wireless device is a reduced capability wireless device according to 3GPP Release 17.

54. The method of claim 41, comprising receiving a further message from the network node, wherein the further message is based at least on the indication of whether the wireless device is a reduced capability wireless device, wherein the further message comprises a RRCSetup or RRCReject message that is based on the indication of whether the wireless device is a reduced capability wireless device.

55. A method performed by a network node of a wireless network for random access, the method comprising:
receiving a Msg3 message from a wireless device, wherein the Msg3 message includes an indication of whether the wireless device is a reduced capability wireless device.

56. The method of claim 55, wherein the Msg3 message includes an Information Element (IE) that indicates whether the wireless device is a reduced capability wireless device, wherein the Information Element contains the indication of whether the wireless device is a reduced capability wireless device, or wherein the Information Element type is selected based on whether the wireless device is a reduced capability wireless device.

57. The method of claim 56, wherein at least one of the following applies: the Information Element is a new information element as compared to a legacy Msg3 message; or wherein the size of the Msg3 message is larger than the size of a legacy Msg3 message.

58. The method of claim 56, wherein the Msg3 message includes a Msg3 bit that indicates whether the wireless device is a reduced capability wireless device.

59. The method of claim 55, wherein Msg3 message includes a Medium Access Control Control Element (MAC CE) that indicates whether the wireless device is a reduced capability wireless device.

60. The method of claim 59, wherein the MAC CE includes a Logical Channel ID (LCID) or enhanced LCID (eLCID) that indicates whether the wireless device is a reduced capability wireless device

61. The method of claim 60, wherein the LCID or eLCID is one of a first plurality of values if the wireless device is a reduced capability wireless device, or a value other than the first plurality of values if the wireless device is not a reduced capability wireless device or is a legacy wireless device, and wherein the first plurality of values comprises a plurality of reserved values in a legacy Msg3 message.

62. The method of claim 55, wherein the Msg3 message indicates an establishment cause (EstablishmentCause) that indicates whether the wireless device is a reduced capability wireless device.

63. The method of claim 55, wherein:
the Msg3 message is transmitted on an uplink common control channel 1 (UL CCCH1), and a MessageType or MessageClassExtension in the Msg3 message indicates whether the wireless device is a reduced capability wireless device; or
the Msg3 message is transmitted on an uplink common control channel 2 (UL CCCH2), and wherein a message class of the Msg3 message indicates whether the wireless device is a reduced capability wireless device.

64. The method of claim 55, wherein the Msg3 message indicates a User Equipment ID (UE ID) of the wireless device, and wherein the UE ID indicates whether the wireless device is a reduced capability wireless device.

65. A wireless device configured for communicating with a wireless network, the wireless device comprising:
a processor; and
a memory associated with the processor and storing computer program instructions that, when executed by the processor cause the wireless device to transmit a Msg3 message to a network node of the wireless network, for performing random access towards the network node, wherein the Msg3 message includes an indication of whether the wireless device is a reduced capability wireless device.

66. A network node configured for operation in a wireless network, the network node comprising:
a processor; and
memory associated with the processor and storing computer program instructions that, when executed by the processor, configure the network node to receive a Msg3 message from a wireless device performing a random access towards the network node, wherein the Msg3 message includes an indication of whether the wireless device is a reduced capability wireless device.
